(19) United States
(12) Patent Application Publication
(10) Pub. No.: US 2002/0178441 A1
(43) Pub. Date: Nov. 28, 2002

(54) Audience rating survey system

(76) Inventor: Minoru Hashimoto, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/079,435

(22) Filed: Feb. 20, 2002

(30) Foreign Application Priority Data
Feb. 20, 2001 (JP) P2001-044232
Oct. 23, 2001 (JP) P2001-324996

(51) Int. Cl. H04N 7/16; H04H 9/00; H04N 7/173

(52) U.S. Cl. 725/11; 725/9; 725/24

(57) ABSTRACT

An audience rating survey system registers user IDs which specify viewers/listeners of a network-distributed program in association with characteristic parameters that indicate characteristics of the viewers/listeners; acquires a user ID, a device ID, and a program ID; and carries out an audience rating survey of the network-distributed program based on the acquired user ID, device ID and program ID, and the characteristic parameters associated with the user ID, thereby allowing for an effective and accurate audience rating survey of, for example, an Internet-broadcasted program.

### CROSS-REFERENCE TO RELATED APPLICATIONS

This application claims priority from Japanese Application Nos. 2001-44232 filed on Feb. 20, 2001 and 2001-324996 filed on Oct. 23, 2001, the disclosures of which are hereby incorporated by reference herein.

### BACKGROUND OF THE INVENTION

The present invention relates to an audience rating survey method and apparatus which are effective, for example, when surveying audience ratings for programs to be distributed via a communications network; a network-distributed program receiving method and apparatus; an audience rating survey system; a recording medium recorded with an audience rating survey program; a recording medium recorded with a control program for a network-distributed program receiving apparatus; an audience rating survey program; and a control program for a network-distributed program receiving apparatus.

In recent years, services for distributing radio programs, television programs and specialized field programs and the like using, for example, what is commonly referred to as streaming distribution over the Internet, have been put to practical use. It is noted that distribution of radio programs and television programs using the Internet will be referred to as Internet broadcasting in the following description.

Meanwhile, what is referred to as an audience rating survey, which compiles the number of viewers/listeners for the respective program time slots, has been conventionally carried out for program broadcasting using typical broadcasting media of radio airwaves or television airwaves and the like. The audience rating survey has become an extremely important tool in determining, especially with programs running advertisements, the advertising effectiveness of those advertisements.

Accordingly, even in Internet broadcasting, it is similarly preferable to carry out an audience rating survey.

However, the conventionally performed audience rating survey can only compile the number of viewers/listeners for each program, and can not survey to the extent of such things as what kind of people are viewing/listening to a certain program. Therefore, it is especially difficult to accurately judge the advertising effectiveness of programs that run advertisements.

### SUMMARY OF THE INVENTION

The present invention takes such problems into consideration, and aims to provide a network-distributed program receiving method and apparatus; an audience rating survey system; a recording medium recorded with an audience rating survey program; a recording medium recorded with a control program for a network-distributed program receiving apparatus; an audience rating survey method; and a control program for a network-distributed program receiving apparatus, allowing for an effective and accurate audience rating survey of, for example, Internet broadcasting.

The present invention registers a user ID, which specifies a viewer/listener of a network-distributed program, in association with characteristic parameters that indicate characteristics of the viewer/listener; acquires, via a predetermined communications network, the user ID of a viewer/listener who is viewing/listening to the network-distributed program, a device ID which specifies the client terminal receiving the network distributed program, and a program ID which specifies the network-distributed program; and carries out an audience rating survey of the network-distributed program based on the acquired user ID, device ID and program ID, and the characteristic parameters associated with the acquired user ID.

The characteristic parameters indicating the characteristics of the viewer/listener may be demographic information for which the viewer/listener has given consent for use in the audience rating survey from among a plurality of demographic information (the user's age, gender, occupation, hobby, annual income, address and such).

Namely, according to the present invention, an audience rating survey is conducted with consideration of the demographic information (the user's age, gender, occupation, hobby, annual income, address and such) of the viewer/listener.

Also according to the present invention, since the user ID, device ID and program ID are acquired via a predetermined communications network, an audience rating survey may be realized in real time with consideration of the demographic information.

### BRIEF DESCRIPTION OF DRAWINGS

FIG. 1 is a system block diagram showing the schematic structure of an audience rating survey system of an embodiment to which the present invention is applied.

FIG. 2 is a block diagram showing the schematic structure of an example of a client terminal of this embodiment.

FIG. 3 is a diagram showing an example of a selection screen for gathering demographic information indicated on the screen of a monitor of the client terminal.

FIG. 4 is a flow chart illustrating the process flow, from acquiring characteristic parameters through a survey server and acquiring and registering a user ID and device ID, to providing client software to the client terminal.

FIG. 5 is a flow chart illustrating the process flow, from accessing the survey server in the client terminal, displaying the selection screen and transmitting the characteristic parameters, to acquiring the client software.

FIG. 6 is a flow chart illustrating the process flow of running the client software at the client terminal while viewing/listening to an Internet-broadcasted program.

FIG. 7 is a flow chart illustrating the process flow for the case where a survey server actually is carrying out an audience rating survey.

### DETAILED DESCRIPTION

Brief Description of Audience Rating Survey Method of the Present Invention

To begin with, an audience rating survey method according to the present invention will be described in brief.

The audience rating survey method of the present invention is a method that allows for the realization of an accurate audience rating survey in the case where such radio programs or television programs (Internet broadcasting) are viewed/listened to using a network-distributed program receiving device (hereafter referred to as a client terminal) that is able to connect with a wide-area communications network, such as the Internet, through the use of a user ID, which specifies each viewer/listener (hereafter referred to as a user), a device ID, which specifies each client terminal, and program IDs, which specify each Internet-broadcasted program, as well as through the use of the demographic information registered in advance by the client.

Here, the user ID is unique identifying information that can specify each user, for example, an ID designated to each member of respective membership services distributing programs through Internet broadcasting, an ID recorded with a mobile phone number, a credit card number, a memory card and the like in each user's possession, and an ID that the user personally establishes (password). It is noted that the recorded ID of the user's memory card is used as the user ID in the embodiments of the present invention.

The device ID is unique identifying information of each terminal such as, in the case of the client terminal being a so-called IEEE (The Institute of Electrical and Electronics Engineers) 1394 device, an (EUI-64 or GUID) ID or a fixed IP address. It is noted that the IEEE 1394 GUID is used as the device ID in the embodiments of the present invention. In addition, the location where the client terminal is established (address, district, etc.) and what type of device it is and the like can be determined from this device ID.

The program ID is identifying information for specifying the Internet-broadcasted programs.

The demographic information includes parameters indicating the characteristics of the user viewing/listening to the program (hereafter referred to as characteristic parameters), such as the user's age, gender, occupation, hobby, annual income and address (residential district or installation site of the client terminal), for example, and includes information used for accurate compilation of the audience rating survey and determination of the effectiveness of the advertisements run in programs. It is noted that with the present invention, of each of the characteristic parameters such as age, gender and occupation, the only parameters actually used for the audience rating survey are those pieces of information for which the user has given consent for use in the audience rating survey. However, it will be appreciated that the more types of characteristic parameters (demographic information) used, the more accurate, effective and precise the audience rating survey achieved may be. Thus, for example, in the case where an advertisement is run during a program, in order to accurately determine the effectiveness of this advertisement, it is necessary to know many characteristic parameters of the viewer/listener that is viewing/listening to that program, such as age, gender, occupation, hobby, annual income and address. Accordingly, in the embodiments of the present invention, a program giving the user incentives proportionate to the number of characteristic parameters provided by the user is employed so as to acquire as many characteristic parameters as possible from the user. In this embodiment, as an example of this incentive program, a prize award system may be employed where, for example, if the number of characteristic parameters provided by the user is made to be the number of entries, there is a better chance of winning promotional gifts according to the number of entries. It is noted that this incentive program is not just a prize award system, but can also be actualized using a computer program within an audience rating survey apparatus operated by an audience rating survey company, for example.

With the audience rating survey method of the present invention, by surveying which user at which terminal is viewing/listening to which Internet-broadcasted program based on a combination of the above user ID, device ID and program ID, as well as by carrying out an audience rating survey which considers the characteristic parameters already entered by the user viewing/listening to the program, not only can the compilation of just the number of viewers/listeners be carried out as in conventional audience rating surveys, but it also becomes possible to survey what ages, genders, occupations, hobbies, annual incomes and addresses of users are viewing/listening to which program.

Schematic Structure of Audience Rating Survey System According to the Embodiments of the Present Invention

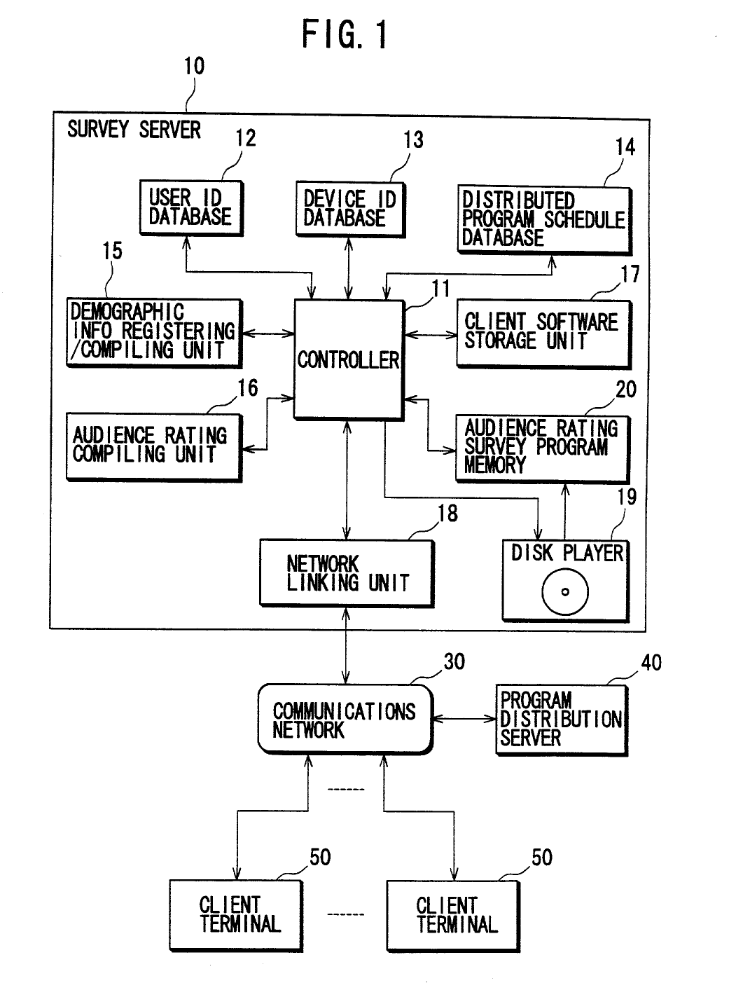

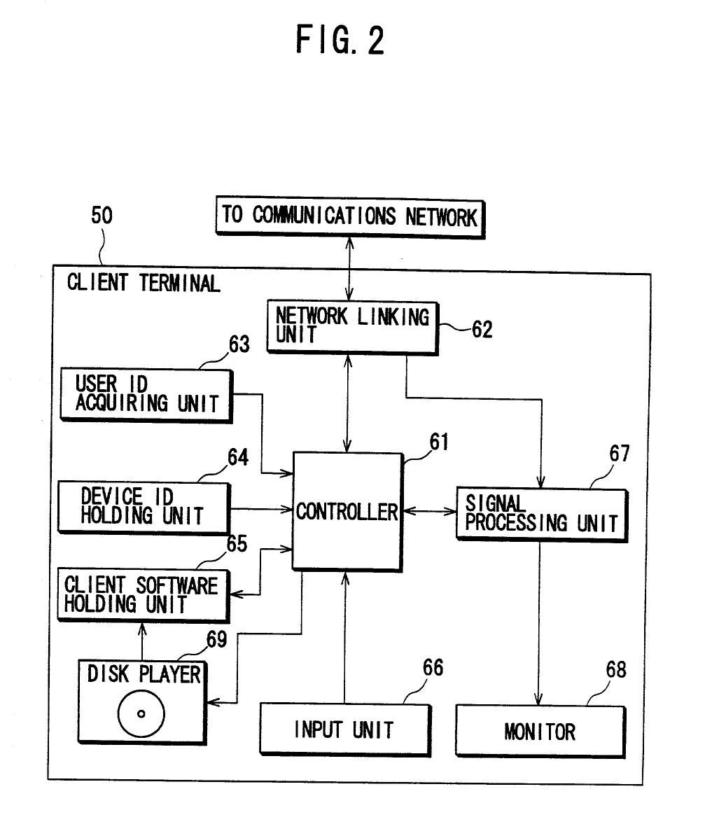

The schematic structure of an embodiment of an audience rating survey system for performing an audience rating survey method of the present invention will be described in the following using FIG. 1 and FIG. 2.

In FIG. 1, the detailed structure of a survey server 10 is shown as the overall structure of the audience rating survey system of this embodiment or, for example, an audience rating survey apparatus operated by a company conducting audience rating surveys.

In FIG. 1, the audience rating survey system of this embodiment comprises at least one survey server 10, program distribution server 40, communications network 30, such as the Internet and the like, and a plurality of client terminals 50. The server 10, program distribution server 40, and client terminals 50 are capable of being linked to the communications network 30.

The client terminals 50 are devices or systems with which each viewer/listener (user) of the Internet-broadcasted program can operate and view/listen to the program, including, for example, personal computers, mobile phones, portable information processing devices or video game devices equipped with communication functions. The detailed structure and operations will be described later; however, by executing a control program as the predetermined client software for the network-distributed program receiving device of the present invention, these client terminals 50 will, for example, operate at every fixed time interval during viewing/listening of the program such that the program ID of the program being distributed (viewed/listened to by the user) is transmitted (uploaded) to the survey server 10 via the communications network 30, the user ID acquired from the user, and the internally held device ID.

The program distribution server 40 is a device or system that distributes various Internet-broadcasted programs via the communications network 30 and may be operated by, for example, a company that distributes program content. It is noted that this program distribution server 40 carries out Internet broadcasting of program contents as well as transmitting the program ID of that program.

The survey server 10 may be operated by an audience rating survey company, for example, and is a device or system that surveys the audience ratings of the above Internet-broadcasted programs. Its principle components include a user ID database 12, a device ID database 13, a distributed-program schedule database 14, a demographic information registering/compiling unit 15, an audience rating compiling unit 16, a client software storage unit 17, a network linking unit 18, a disk player 19, an audience rating survey program holding unit 20, and a controller 11 which controls the operations of each of these components. Detailed steps of the controlling operations of this controller 11 will be described later.

The network linking unit 18 is an interface for linking to a communications network 30, such as the Internet. The client software storage unit 17 stores the predetermined client software that runs when the client terminal 50 is used to view/listen to the program.

The user IDs of a plurality of viewers/listeners receiving the Internet broadcast are databased and stored by the user ID database 12. The device IDs of a plurality of client terminals 50 receiving the Internet broadcast are databased and stored by the device ID database 13. The demographic information registering/compiling unit 15 registers and compiles the characteristic parameters (demographic information) which are entered in advance by each user, associated with the user ID.

The distributed-program schedule database 14 acquires the broadcasting schedule of each program (hereafter referred to as the program schedule) distributed through the program distribution server 40 and the program IDs of each program, and databases and stores the associations between these program IDs and program schedules.

The audience rating compiling unit 16 compiles the audience rating of the network broadcasted programs based on the user IDs, device IDs and program IDs that are uploaded every fixed time interval from the client terminals 50 by running the predetermined client software therewith; the user IDs, device IDs and program IDs stored in each of the databases 12, 13 and 14; and the characteristic parameters held in the demographic information registering/compiling unit 15.

When, for example, a recording medium such as a CD-ROM or DVD-ROM recorded with the audience rating survey program of this embodiment is loaded, the disk player 19 reads the audience rating survey program from that recording medium under the control of the controller 11.

The audience rating survey program memory unit 20 stores the audience rating survey program of this embodiment that the disk player 19 has read from the recording medium. It is noted that the audience rating survey program held by the audience rating survey program holding unit 20 may also be acquired from, for example, program-sponsoring vendors and the like via the network 30.

Meanwhile, a client terminal 50 has a configuration such as that shown in FIG. 2.

Namely, the principle components of the client terminal 50 include a network linking unit 62, a user ID acquiring unit 63, a device ID holding unit 64, a client software holding unit 65, an input unit 66, a signal processing unit 67, a monitor 68, a disk player 69, and a controller 61 which controls the operations of each of these principle components. It is noted that detailed steps of the controlling operation of this controller 61 will be described later.

The network linking unit 62 is an interface for linking to a communications network 30, such as the Internet. The client software holding unit 65 is a recording unit for holding predetermined client software that has been downloaded from the survey server 10 via, for example, the communications network 30.

It is noted that in this embodiment, an example is given where the predetermined client software is downloaded from the survey server 10 and provided to client terminals 50; however, the client software may also be provided to the client terminals 50 by a recording medium such as, for example, a CD-ROM or a DVD-ROM. In this case, the recording medium upon which the client software is recorded is loaded into the disk player 69. The disk player 69 reads the client software from this recording medium under the control of the controller 61. In addition, the client software holding unit 65 holds the client software that has been read from this recording medium.

The ID acquiring unit 63 has a configuration for acquiring the user IDs. In an example of this embodiment, the ID recorded in the memory card in the possession of the user is used as the user ID; accordingly, this user ID acquiring unit 63 acquires the user ID by reading the ID recorded on the memory card.

The device ID holding unit 64 is a storing unit for holding the pre-established device ID of these client terminals 50. In an example of this embodiment, these client terminals 50 are made to be IEEE 1394 devices; accordingly, this device ID holding unit 64 holds the device ID as an IEEE 1394 GUID.

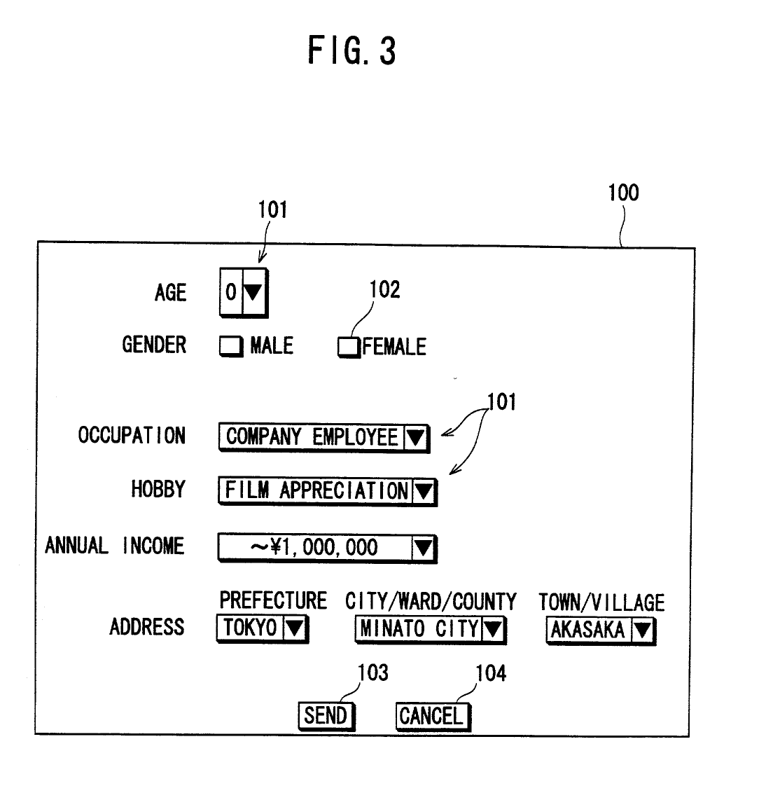

The signal processing unit 67 receives the program data that is distributed from the program distribution server 40, and the data used for display of the selection screen shown in FIG. 3 which the survey server 10 has transmitted for gathering characteristic parameters (demographic information), and converts them into visual signals and audio signals which are transmitted to the monitor 68. As a result, through the monitor 68, the images and sound of the program are output (displayed and produced, respectively), and the images and such of the selection screen of FIG. 3 are output (displayed).

The input unit 66 is used by the user to select (enter) each selection option displayed upon the selection screen; for example, it can be an operation controller or a mouse so as to operate the cursor keys displayed on the screen.

Here, each of the selection options, such as age, gender, occupation, hobby, annual income and address, for example, are displayed upon a selection screen 100 shown in FIG. 3, which is used for gathering the characteristic parameters. Each of these selection options is comprised of, for example, entries that may have a minimum requirement or those allowing a choice, and with each selection option there is displayed, for example, what is referred to as a drop-down list box 101 or check box 102 or the like, where it is possible for the user to enter (select) characteristic parameters using these boxes 101 and 102. With the audience rating survey system of this embodiment, when the user pushes (clicks) a send button 103 after having entered each of the selecting entries, it is interpreted as the user giving consent for use of the characteristic parameters (demographic information) corresponding to each of the input selection options in the audience rating survey (consent for disclosure to the audience rating survey companies). It is noted that a cancel button 104 is provided on the selection screen 100 for canceling the transmission. Moreover, it is possible for each characteristic parameter the user has initially given consent for to be changed (added or deleted) at a later time according to the user's volition.

Flow of Audience Rating Survey in Audience Rating Survey System According to the Embodiments of the Present Invention

Preliminary Processing of Audience Rating Survey in Survey Server

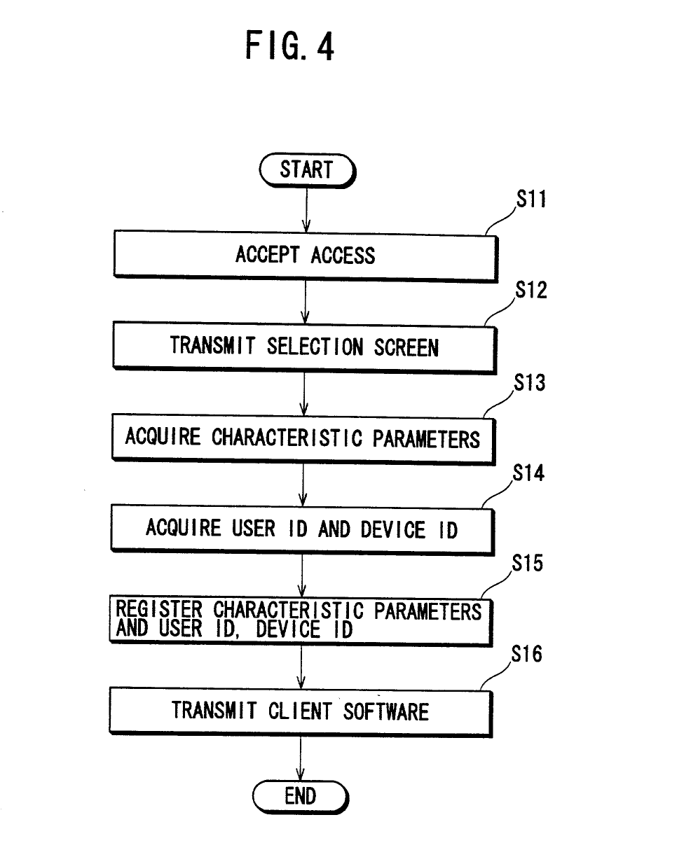

The process flow of acquiring characteristic parameters (demographic information) from the survey server 10, acquiring and recording the user IDs and device IDs, and providing client software to client terminals 50 is shown in FIG. 4. The process shown in FIG. 4 is the processing involved in the stage before actually carrying out the audience rating survey. It is noted that the flow chart illustrated in FIG. 4 is mainly the process carried out by the controller 11 of the survey server 10 based on the audience rating survey program of the present invention, which is a computer program. Moreover, the flow chart of FIG. 4 is the process flow in the case where the client software is transmitted (downloaded) from the survey server 10 to the client terminals 50.

In FIG. 4, the controller 11 of the survey server 10 accepts participative access to the audience rating survey from the client terminals 50 via the communications network 30 or network linking unit 18 in the processing during initial step S11. Then, in the processing during second step S12, the data used for the selection screen display, which is used for gathering characteristic parameters previously mentioned in connection with FIG. 3, is transmitted to the client terminals 50 that have gained access. Through this, the selection screen 100 is displayed as shown in FIG. 3 through the monitor 68 of these client terminals 50. It is noted that transmitting data used for the selection screen display to the client terminals is possible not only when access to participate in the audience rating survey has been gained by each client terminal, but can also be transmitted to, for example, client terminals that have been randomly selected by the survey server 10 out of the plurality of client terminals that are receiving Internet broadcast distributions. In this sort of case where client terminals are randomly selected, since users other than those that seek to participate in the audience rating survey by their own volition are also allowed to participate in the audience rating survey, a more balanced audience rating survey may be achieved.

Next, the controller 11 acquires the characteristic parameters that have been transmitted from the client terminals 50 during the processing of step S13, and further acquires device IDs of the client terminals 50 that have transmitted the characteristic parameters and the user IDs of the users operating these terminals 50 during the processing of step S14.

Moreover, during the processing of step S15, the controller 11 associates the acquired characteristic parameters with the user IDs and registers them with the demographic information registering/compiling unit 15, and registers the user IDs in the user ID database 12 and the device IDs in the device ID database 13.

Afterward, during the processing of step S16, the client software is transmitted, for example after compression, to the client terminals 50 that have sent in the characteristic parameters, user IDs and device IDs. It is noted that when client software is provided via a recording medium, the controller 11 transmits to the client terminals 50 a request for data necessary to be input, for example, the address, contact telephone number, and the like of the recipient of the recording medium. Later, this information including the address, contact telephone number, and the like of the recipient will be passed on from the survey server 40 to, for example, a recording medium distribution company. The recording medium upon which the client software has been recorded is sent to the users of the client terminals 50 through, for example, the postal service and the like. Accordingly, the client terminals 50 are able to receive the recording medium upon which the client software has been recorded.

Preliminary Processing of Audience Rating Survey in Client Terminals

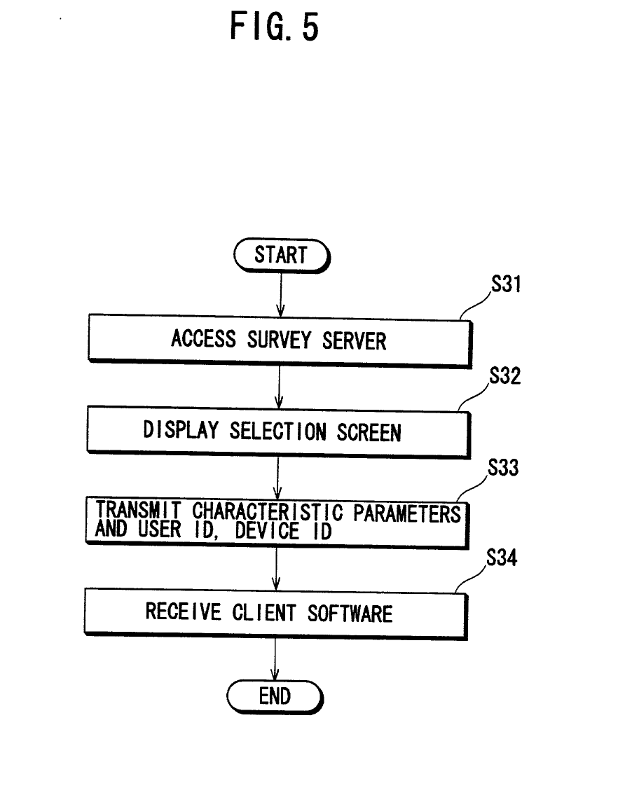

Next, the process flow of gaining access to the survey server 10, displaying the selection screen, transmitting the characteristic parameters (demographic information), and acquiring the client software by the client terminals 50 is shown in FIG. 5. The process shown in FIG. 5 is processing involved in the stage before actually carrying out the audience rating survey. It is noted that the process illustrated in FIG. 5 is the process carried out for the most part by the controller 61 of the client terminals 50 and is based on access/browse software (also referred to as web browsing software). Furthermore, the flowchart of FIG. 5 is the process flow in the case where the client software is transmitted (downloaded) from the survey server 10 to the client terminals 50.

As shown in FIG. 5, during the processing of initial step S31, the controller 61 of the client terminals 50 accesses the survey server 10 via the communications network 30 or network linking unit 62, and receives the data used for the selection screen display, which is used for gathering characteristic parameters previously mentioned with respect to FIG. 3, that has been transmitted from the survey server 10. As a result, the selection screen 100 shown in FIG. 3 is displayed on the monitor 68 of these client terminals 50 during the processing of step S32.

Next, during the processing of step S33, the controller 61 transmits the characteristic parameters entered on the selection screen 100 by the users operating the input unit 66, the user IDs acquired by the user ID acquiring unit 63, and the device IDs that are held by the device ID holding unit 64 to the survey server 10 via the network linking unit 62 or communications network 30.

Afterwards during the processing of step S34, the controller 61 receives (downloads) the client software that is sent from the survey server 10, storing it within the client software holding unit 65. After the downloaded client software is decompressed, it is installed in the client terminals 50. It is noted that in the case where the client software is provided as a recording medium, the controller 61 controls the disk player 69, reads the client software from that recording medium, and then holds it in the client software holding unit 65.

Flow of Processing of the Client Software at the Client Terminals

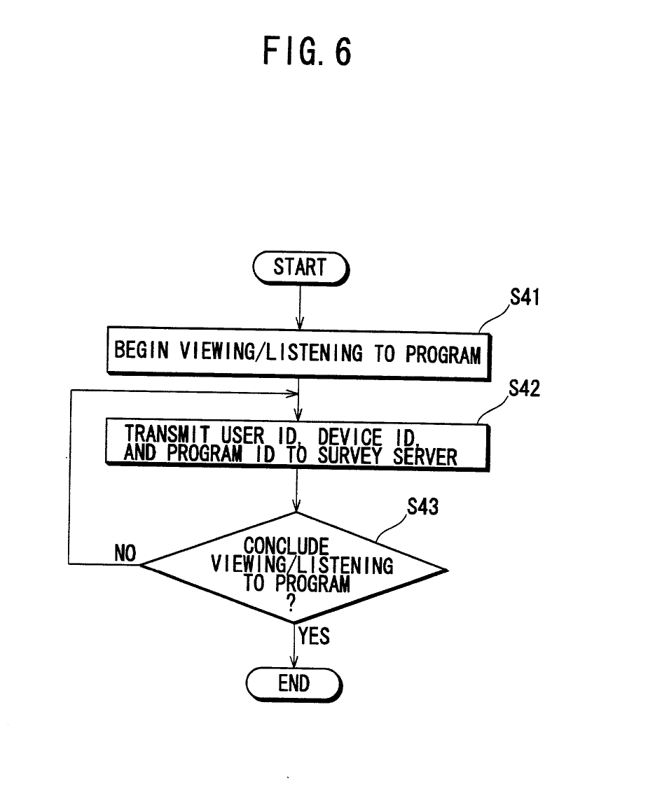

The process flow of carrying out the client software installed in the client terminals 50 in the case where the users are actually viewing/listening to an Internet broadcasted program using the client terminals 50 is shown in FIG. 6. It is noted that the flow chart illustrated in FIG. 6 is the process that the controller 61 of the client terminals 50 carries out mainly based on the client software. Furthermore, as resident software, this client software acts to monitor whether or not Internet-broadcasted programs are being viewed by the client terminals 50.

In FIG. 6, during the processing of initial step S41, the controller 61 of the client terminals 50 starts the viewing/listening to the Internet-broadcasted program that the program distribution server 40 distributes via the communications network 30 or network linking unit 62, and during step S42, transmits (uploads) to the survey server 10 the user IDs acquired through the user ID acquiring unit 63, the device IDs held in the device ID holding unit 64 and the program IDs of the programs that are being viewed/listened to during every fixed time interval.

Afterwards, during the processing of step S43, the controller 61 determines whether the viewing/listening to the program has concluded, repeating the process of steps S42 and S43 as long as the viewing/listening has not ended.

Flow of the Actual Audience Rating Survey in the Survey Server

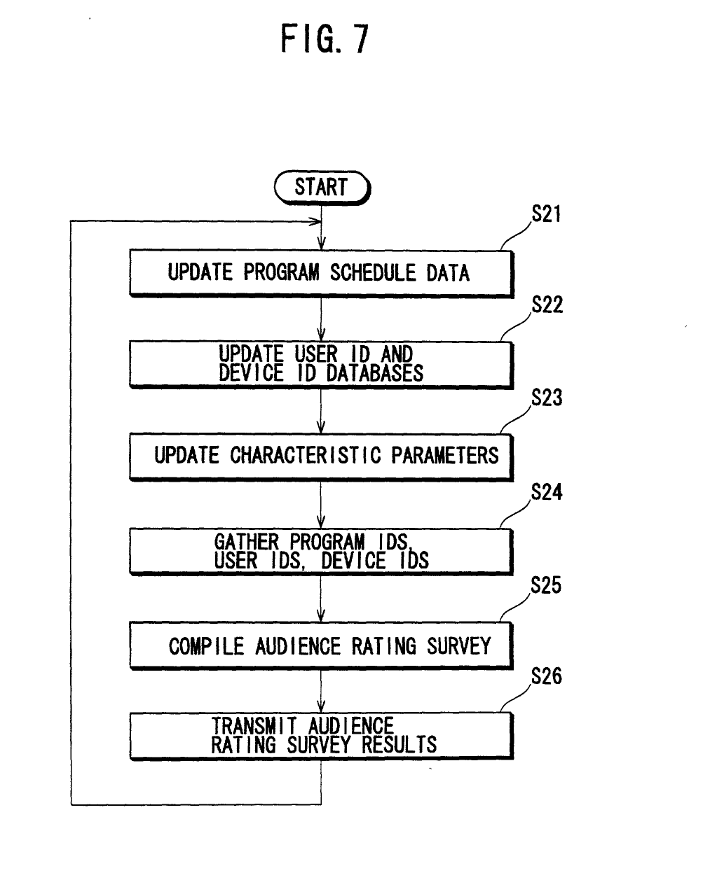

Flow of the process when the survey server 10 actually carries out the audience rating survey is shown in FIG. 7. It is noted that the flowchart illustrated in this FIG. 7 is the process that the controller 11 of the survey server 10 or audience rating compiling unit 16, for example, carries out based mainly on the audience rating survey program of the present invention, which is being held in the audience rating survey program holding unit 20.

In FIG. 7, during the processing of initial step S21, the controller 11 of the survey server 10 acquires the program schedule data of the Internet-broadcasted programs from the program distribution server 40 via the communications network 30 or network linking unit 18 so as to update the distributed-program schedule database 14.

Furthermore, during the processing of step S22, in order to account for participation in the audience rating survey by new users and client terminals or oppositely withdrawal from the survey by users and client terminals, the controller 11 updates the user IDs, which are registered in the user ID database 12, and the device IDs, which are registered in the device ID database 13, as needed.

Similarly, during the processing of step S23, in order to account for situations in which changes (addition or deletion) in already registered characteristic parameters are requested by the user, the controller 11 updates the characteristic parameters registered in the demographic information registering/compiling unit 15 as needed.

Next, during the processing of step S24, the controller 11 receives the user IDs, device IDs and program IDs that are sent at every fixed time interval from the client terminals 50 where the users are viewing/listening to the Internet-broadcasted program, and then transmits the received IDs to the audience rating compiling unit 16.

During the processing of step S25, the audience rating survey compiling unit 16 compares each ID and such that are housed in the respective databases 12, 13 and 14 to the received user IDs, device IDs and program IDs; retrieves the characteristic parameters recorded in the demographic information-registering/compiling unit 15; and carries out real time compilation of the audience rating based on demographic information such as the user's age, gender, hobby, occupation, annual income, and address, utilizing these characteristic parameters and user IDs, and the device IDs and program IDs. In other words, the audience rating compiling unit 16 looks at, for example, what age, which gender, what sort of hobbies, what occupation, how much annual income, and which address of user is viewing/listening to the Internet-broadcasted programs as the results of the audience rating compilation.

Afterwards, during the processing of step S26, the controller 11 transmits the results of the audience rating total that has been compiled by the audience rating compiling unit 16 to, for example, the program distribution company, which operates a program distribution server 40, and to the advertisers that are sponsoring each program. As a result, the program distribution companies and the advertisers can know the audience ratings for those programs, and it becomes possible to estimate the advertising effectiveness of the advertisements run with those programs.

It is noted that it is also possible to transmit the above results of the audience rating compilation to those client terminals 50 viewing/listening to the above Internet-broadcasted programs. In this manner, in the case where the audience rating survey results are transmitted to the client terminals 50, for example, if the audience rating survey results are displayed through the monitor 68 of these client terminals 50, the user is able to know what other sorts of people are viewing the program she/he is viewing.

As described above, according to the audience rating survey system of the embodiments of the present invention, an audience rating survey taking into account the demographic information the audience rating survey company desires can be carried out in real time within limits the user has agreed upon for the audience rating survey, thus allowing for an effective and accurate audience rating survey for Internet broadcasting.

Namely, according to this embodiment, not only is the number of viewers/listeners compiled as with conventional audience rating surveys, but may be carried out in real time and while considering demographic information. Furthermore, it allows for the provision of accurate information regarding the users actually viewing those programs and advertisements to program distribution companies delivering the Internet-broadcasted programs, and, for example, the advertisers running advertisements with these programs. As a result, the program distribution companies can set the appropriate advertisement placement rate for these programs, and it is possible for the advertisers to optimize the contents of the advertisements run with these programs to the characteristics of the user viewing/listening to the programs.

Moreover, audience rating surveys for programs broadcast through conventional broadcasting media have established exclusive hardware for audience rating surveying at, for example, a limited number of households using random sampling by an audience rating survey company, and have been carried out solely based on information (number of viewers/listeners) acquired by these limited numbers of exclusive hardware for audience rating surveying. However, according to an audience rating survey system of the embodiments of the present invention, candidates for participation in the audience rating survey may be recruited on the Internet, and as long as the user has access to the Internet, any type of user may participate in the audience rating survey, thus allowing for abundant users.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of conducting an audience rating survey for programs distributed over a computer network to individual client terminals, comprising:
registering a user ID for each user in a potential audience for a network-distributed program, and registering characteristic parameters which indicate characteristics of a user in association with the user ID of the user;
acquiring, via a predetermined communications network, the user IDs of each user in an audience who is receiving the network-distributed program, a device ID for each of the client terminals receiving the network-distributed program, and a program ID which specifies the network-distributed program; and
determining an audience rating of the network-distributed program based on the acquired user IDs, device IDs and program ID, and the characteristic parameters associated with the acquired user IDs.

2. The audience rating survey method according to claim 1, further comprising:
setting the characteristic parameters as demographic information for which each user has given consent for use in an audience rating survey;
retrieving the characteristic parameters associated with the acquired user IDs from the registered characteristic parameters; and
utilizing the retrieved characteristic parameters during the audience rating survey.

3. The audience rating survey method according to claim 2, further comprising:
providing to each client terminal selection screen information including a plurality of demographic information from which each user selects the demographic information for which to give consent for use in the audience rating survey; and
registering the selected demographic information for each user as the characteristic parameters for the user in association with the user ID of the user.

4. The audience rating survey method according to claim 3, further comprising:
establishing incentives corresponding to the amount of the demographic information selected by the user.

5. The audience rating survey method according to claim 1, wherein the acquiring step includes
acquiring the user IDs, the device IDs and the program ID at fixed time intervals.

6. The audience rating survey method according to claim 1, further comprising:
updating the registered characteristic parameters of the users.

7. The audience rating survey method according to claim 1, wherein
the predetermined communications network is the Internet.

8. An audience rating survey apparatus, comprising:
a network linking unit operable to link to a predetermined network;
a characteristic parameter registering unit operable to register a user ID for each user in a potential audience for a network-distributed program and to register characteristic parameters which indicate characteristics of a user in association with the user ID of the user;
an ID acquiring unit operable to acquire via the predetermined network a user ID of each user in an audience who is receiving the network-distributed program, a device ID for each client terminal receiving the network-distributed program, and a program ID which specifies the network-distributed program; and
an audience rating survey unit operable to determine an audience rating of the network-distributed program based on the acquired user IDs, device IDs and program ID, and the characteristic parameters associated with the acquired user IDs.

9. The audience rating survey apparatus according to claim 8, wherein
the characteristic parameter registering unit sets as the characteristic parameters demographic information for which each user has given consent for use in an audience rating survey; and
the audience rating survey unit retrieves the characteristic parameters associated with the acquired user IDs from the registered characteristic parameters, and utilizes the retrieved characteristic parameters during the audience rating survey.

10. The audience rating survey apparatus according to claim 9, further comprising:
a selection screen information providing unit operable to provide to each client terminal selection screen information including a plurality of demographic information from which each user selects the demographic information for which to give consent for use in the audience rating survey;
wherein the characteristic parameter registering unit registers the selected demographic information for each user as the characteristic parameters for the user in association with the user ID of the user.

11. The audience rating survey apparatus according to claim 8, wherein
the ID acquiring unit acquires the user IDs, the device IDs, and the program ID at fixed time intervals.

12. The audience rating survey apparatus according to claim 11, further comprising:
a program providing unit operable to provide a computer program to each client terminal for uploading the user IDs, the device IDs and the program ID at each fixed time interval by downloading the computer program to each client terminal.

13. The audience rating survey apparatus according to claim 8, further comprising:
a parameter updating unit operable to update the registered characteristic parameters of the users.

14. The audience rating survey apparatus according to claim 8, wherein
the predetermined communications network is the Internet.

15. A method of receiving network-distributed programs, comprising:
storing a device ID;
acquiring a user ID for a user in a potential audience for a network-distributed program;
receiving the network-distributed program via a predetermined network;
acquiring a program ID of the network-distributed program; and
at fixed time intervals while the network-distributed program is being received, transmitting the user ID, the device ID and the program ID to a predetermined apparatus that determines an audience rating.

16. The network-distributed program reception method according to claim 15, further comprising:
displaying a selection screen including a plurality of demographic information from which the user selects demographic information for which to give consent for use in an audience rating survey;
acquiring as characteristic parameters that indicate characteristics of the user the demographic information selected by the user; and
transmitting the characteristic parameters along with the user ID of the user to the predetermined apparatus.

17. The network-distributed program reception method according to claim 16, further comprising:
updating the characteristic parameters of the user; and
transmitting the updated characteristic parameters to the predetermined apparatus.

18. The network-distributed program reception method according to claim 15, wherein
the predetermined network is the Internet.

19. A network-distributed program receiving apparatus, comprising:
a device ID storing unit;
a user ID acquiring unit operable to acquire a user ID for a user in a potential audience for a network-distributed program;
a network-distributed program receiving unit operable to receive the network-distributed program via a predetermined network;
a program ID acquiring unit operable to acquire a program ID of the network-distributed program; and
an ID transmitting unit operable to transmit the user ID, the device ID and the program ID to a predetermined apparatus that determines an audience rating at fixed time intervals while the network-distributed program is being received.

20. The network-distributed program receiving apparatus according to claim 19, further comprising:
a selection screen providing unit operable to display a selection screen including a plurality of demographic information from which the user selects demographic information for which to give consent for use in an audience rating survey;
an input unit with which the user inputs instructions; and
a characteristic parameter acquiring unit operable to acquire, as characteristic parameters that indicate characteristics of the user, the demographic information selected according to an instruction input through the input unit by the user;
wherein the characteristic parameters are transmitted along with the user ID of the user from the ID transmitting unit to the predetermined apparatus.

21. The network-distributed program receiving apparatus according to claim 20, wherein
the characteristic parameters acquiring unit updates the characteristic parameters of the user; and
the ID transmitting unit transmits the updated characteristic parameters to the predetermined apparatus.

22. The network-distributed program receiving apparatus according to claim 19, further comprising:
a program storage unit operable to receive via the predetermined network and to store a computer program for transmitting the user ID, the device ID and the program ID at fixed time intervals to the predetermined apparatus.

23. The network-distributed program receiving apparatus according to claim 19, wherein
the predetermined network is the Internet.

24. An audience rating survey system, comprising:
a network-distributed program receiving apparatus, including:
a device ID storing unit;
a user ID acquiring unit operable to acquire a user ID for a user in a potential audience for a network-distributed program;
a network-distributed program receiving unit operable to receive the network-distributed program via a predetermined network;
a program ID acquiring unit operable to acquire a program ID of the network-distributed program; and
an ID transmitting unit operable to transmit the user ID, the device ID and the program ID at fixed time intervals while the network-distributed program is being received; and
an audience rating survey apparatus, including:
a network linking unit operable to link to the predetermined network;
a characteristic parameter registering unit operable to register a user ID for each user in a potential audience for the network-distributed program and to register characteristic parameters which indicate characteristics of a user in association with the user ID of the user;
an ID acquiring unit operable to acquire the user ID, the device ID and the program ID transmitted from the network-distributed program receiving apparatus; and
an audience rating survey unit operable to determine an audience rating of the network-distributed program based on the acquired user ID, device ID and program ID, and the characteristic parameters associated with the acquired user ID.

25. The audience rating survey system according to claim 24, wherein
the characteristic parameter registering unit sets as the characteristic parameters demographic information for which the user has given consent for use in an audience rating survey; and
the audience rating survey unit retrieves the characteristic parameters associated with the acquired user ID from the registered characteristic parameters, and utilizes the retrieved characteristic parameters during the audience rating survey.

26. The audience rating survey system according to claim 25, wherein the audience rating survey apparatus further includes:
a selection screen information providing unit operable to provide to the network-distributed program receiving apparatus selection screen information including a plurality of demographic information from which the user selects demographic information for which to give consent for use in the audience rating survey; and
the characteristic parameter registering unit registers the selected demographic information as the characteristic parameters for the user in association with the user ID of the user.

27. The audience rating survey system according to claim 26, wherein the network-distributed program receiving apparatus further includes:
a selection screen providing unit operable to provide a selection screen for displaying the selection screen information;
an input unit with which the user inputs instructions; and
a characteristic parameter acquiring unit operable to acquire, as the characteristic parameters of the user, the demographic information selected according to an instruction input through the input unit by the user;
wherein the characteristic parameters are transmitted along with the user ID of the user from the ID transmitting unit to the audience rating survey apparatus.

28. The audience rating survey system according to claim 27, wherein the audience rating survey apparatus further includes:
a program providing unit operable to provide by downloading to the network-distributed program receiving apparatus a computer program for uploading the user ID, the device ID and the program ID at the fixed time intervals.

29. The audience rating survey system according to claim 28, wherein the network-distributed program receiving apparatus further includes:
a program storage unit operable to store the computer program downloaded from the audience rating survey apparatus.

30. The audience rating survey system according to claim 24, wherein
the network-distributed program receiving apparatus transmits updated characteristic parameters to the audience rating survey apparatus.

31. The audience rating survey system according to claim 24, wherein
the predetermined network is the Internet.

32. A computer-readable recording medium recorded with an audience rating survey program, the audience rating survey program comprising:
registering a user ID for each user in a potential audience for a network-distributed program, and registering characteristic parameters which indicate characteristics of a user in association with the user ID of the user;
acquiring, via a predetermined communications network, the user IDs of each user in an audience who is receiving the network-distributed program, a device ID for each client terminal receiving the network-distributed program, and a program ID which specifies the network-distributed program; and
determining an audience rating of the network-distributed program based on the acquired user IDs, device IDs and program ID, and the characteristic parameters associated with the acquired user IDs.

33. The computer-readable recording medium according to claim 32, wherein the audience rating survey program further comprises:
setting the character parameters as demographic information for which each user has given consent for use in an audience rating survey;
retrieving the characteristic parameters associated with the acquired user IDs from the registered characteristic parameters; and
using the retrieved characteristic parameters during the audience rating survey.

34. The computer-readable recording medium according to claim 33, wherein the audience rating survey program further comprises:
providing to each client terminal selection screen information including a plurality of demographic information from which each user selects the demographic information for which to give consent for use in the audience rating survey; and
registering the selected demographic information for each user as the characteristic parameters for the user in association with the user ID of the user.

35. The computer-readable recording medium according to claim 34, wherein the audience rating survey program further comprises:
establishing incentives corresponding to the amount of the demographic information selected by the user.

36. The computer-readable recording medium according to claim 32, wherein the audience rating survey program further comprises:
acquiring the user IDs, the device IDs and the program ID at fixed time intervals.

37. The computer-readable recording medium according to claim 32, wherein the audience rating survey program further comprises:
updating the registered characteristic parameters of the users.

38. The computer-readable recording medium according to claim 32, wherein, in the acquiring step, the predetermined communications network is the Internet.

39. A computer-readable recording medium recorded with a control program for a network-distributed program receiving apparatus, the control program comprising:
storing a device ID;
acquiring a user ID for a user in a potential audience for a network-distributed program;
receiving the network-distributed program via a predetermined network;
acquiring a program ID of the network-distributed program; and
at fixed time intervals while the network-distributed program is being received, transmitting the user ID, the device ID and the program ID to a predetermined apparatus that determines an audience rating.

40. The computer-readable recording medium according to claim 39, wherein the control program further comprises:
displaying a selection screen including a plurality of demographic information from which the user selects demographic information for which to give consent for use in an audience rating survey;
acquiring as characteristic parameters that indicate characteristics of the user the demographic information selected by the user; and
transmitting the characteristic parameters along with the user ID of the user to the predetermined apparatus.

41. The computer-readable recording medium according to claim 40, wherein the control program further comprises:
updating the characteristic parameters of the user; and
transmitting the updated characteristic parameters to the predetermined apparatus.

42. The computer-readable recording medium according to claim 39, wherein, in the program receiving step, the predetermined network is the Internet.
